(19) United States
(12) Patent Application Publication
(10) Pub. No.: US 2002/0020808 A1
(43) Pub. Date: Feb. 21, 2002

(54) Optical touch switcing device

(76) Inventor: Takumi Kado, Hadano-shi (JP)

Correspondence Address: MORGAN, LEWIS & BOCKIUS, 1800 M STREET NW, WASHINGTON, DC, 20036-5869, US

(21) Appl. No.: 09/893,506

(22) Filed: Jun. 29, 2001

(30) Foreign Application Priority Data
Jun. 29, 2000 (JP) HEI 2000-195482

(51) Int. Cl. H01P 1/00

(52) U.S. Cl. 250/229

(57) ABSTRACT

An optical touch switching device includes a plurality of switches using a light emitting device and a photodetector. The light emitting device is provided for each switch, while at least one photodetector is provided. A light guiding member is provided between the light emitting device and the switch operating surface. When a finger does not approach or come in contact with the operating surface, the outgoing light from the light emitting device is transmitted through the light guiding member to emit light outwardly. When a finger approaches or comes in contact with the operating surface, the outgoing light is reflected by the finger and guided to the photodetector through the light guiding member. Judgment of switch operation can be performed by the output of the photodetector. The thickness of the light guiding member can be varied for a optical switch device having switch surfaces at different elevations.

This invention claims the benefit of Japanese Patent Application No. 2000-195482 filed on Jun. 29, 2000, which is hereby incorporated by reference.

### BACKGROUND OF THE INVENTION

1. Field of the Invention

The present invention relates to an operation panel provided for apparatus such as household electric appliances, vending machines, vehicle equipment, or the like, and more specifically, relates to an optical touch switching device of an operation panel.

2. Description of the Related Art

A conventional optical touch switching device will be described, with reference to FIG. 6-FIG. 8. FIG. 6 is a sectional view of an optical touch switch 80, wherein reference numeral 81 denotes a light emitting device, 82 denotes a photodetector, 83 denotes a printed board on which the light emitting device and the photodetector are mounted, 84 denotes a switch cover made of a light transmitting resin, and 85 denotes an operation panel of the apparatus. The conventional optical touch switching device may include one optical touch switch described above, or a plurality of optical touch switches described above can be arranged on the operation panel to thereby constitute an optical touch switching device. Information is input to the apparatus using this switching device.

FIG. 7 is a diagram showing the state when the switch is not operated. Here, light 86 is emitted from the light emitting device 81. Since the light 86 passes through the switch cover 84, this light does not enter into the photodetector 82.

FIG. 8 is a diagram showing the state when the switch is operated, wherein a finger F comes in contact with the surface of the switch cover 84. In this state, the light 86 emitted from the light emitting device 81 is reflected by the finger F which is in contact with the surface of the switch cover 84 and enters into the photodetector 82. This incident light is received by the photodetector to generate photoelectric current, which is processed by a detection circuit (not shown) to judge whether a switch operation has been performed or not. Since such a switching device uses light, it has an electric noise resistance, and the durable life of the switching device is also long. Therefore, this type of switching device is often used for apparatus in which such properties are required.

When a plurality of conventional optical touch switches, for example, ten, are used for an operating panel, then ten light emitting elements and ten photodetectors are necessary. This makes the whole apparatus expensive.

A plurality of conventional optical touch switches can be used when the operating surface is planar. However, in a non-planar operation panel having different operating surface planes, a conventional optical touch switching device cannot be used since the gap between the printed board 83 and the operating surface is not constant from one operating surface to another.

Another problem with conventional optical touch switching devices is the difficulty in operating the switch during the night, because it is dark around the switch. Also, when the switch is operated, it is required to provide a pilot lamp specially for confirming if the switch has been operated correctly or not.

### SUMMARY OF THE INVENTION

The present invention is directed to an optical touch switching device that substantially obviates one or more of the problems due to limitations and disadvantages of the related art.

According to one aspect of the present invention, an operating panel having a plurality of optical touch switching devices can be formed of ten light emitting devices, for example, but requires only at least one photodetector and one light guiding member. This construction decreases the material cost, thereby enabling cost reduction of the operating panel.

In another aspect of the present invention an optical touch switching device can be applied to a operating panel having a non-planar surface.

In another aspect of the present invention, the optical touch switching device can be made to emit light for the purpose of illuminating the switch when the light emitting device does not emit light for the purpose of switching, and that the light emitting device can emit light to indicate whether the switch has been operated correctly or not.

### BRIEF DESCRIPTION OF THE DRAWINGS

The nature, principle, and utility of the invention will become more apparent from the following detailed description when read in conjunction with the accompanying drawings in which like parts are designated by identical reference numerals, in which:

FIG. 1 is a sectional view of an optical touch switching device according to a preferred embodiment of the invention;

FIG. 2 is a sectional view in the case where the optical touch switching device of the to preferred embodiment of the invention is operated;

FIG. 3 is a plan view of an operating section, in which four optical touch switches according to an alternate embodiment of the invention are used;

FIG. 4 is a sectional view taken along the line X-X in FIG. 3, when the optical touch switching device of the alternate embodiment of the invention is operated;

FIG. 5 is a sectional view showing the operation of a switch according to another alternate embodiment of the invention in which an operation panel has a non-planar surface;

FIG. 6 is a sectional view of a conventional optical touch switching device;

FIG. 7 is a diagram for explaining the case where a conventional optical touch switching device is not operated; and

FIG. 8 is a diagram for explaining the case where a conventional optical touch switching device is operated.

### DETAILED DESCRIPTION OF THE PREFERRED EMBODIMENT

FIG. 1 is a sectional view for explaining the principle of an optical touch switching device 1 according to a preferred embodiment of the invention. In the optical touch switching device 1, reference numeral 2 denotes a light emitting device, 3 denotes light emitted from the light emitting device 2, 4 denotes a photodetector, 5 denotes a light guiding member, and 6 denotes a shading member. The light emitting device 2 is preferrably a visible light emitting device, but other light emitting devices can be used, such as an infrared light emitting device. The photodetector 4 is an element for detecting the outgoing light from the light emitting device 2. The shading member 6 prevents the light emitted from the light emitting device 2 from directly entering into the photodetector 4. The shading member 6 is an optional feature and can be omitted when such prevention is unnecessary or undesired. In FIG. 1, the light 3 emitted from the light emitting device 2 passes through the light guiding member 5 and outside of the switching device 1. Hence the light does not enter into the photodetector 4 directly.

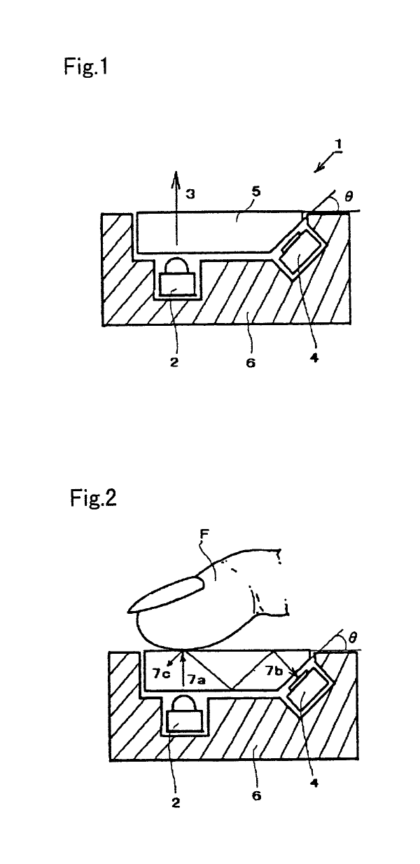

FIG. 2 shows a sectional view when the optical touch switching device 1 in FIG. 1 is in operation. A finger F is brought into contact with the surface of the light guiding member 5 arranged above the light emitting device 2. The outgoing light 7a emitted from the light emitting device 2 is reflected by the finger F, and the reflected light becomes diffused light spreading in all directions. A part of the light is totally reflected and becomes totally reflected light 7b which travels back through the light guiding member 5. Then, the reflected light 7b enters into the photodetector 4 disposed in the vicinity of the end face of the light guiding member 5. Almost all light 7c which does not satisfy the total reflection condition is emitted outside of the light guiding member 5, and some light may be reflected within the light guiding member 5 and enter into the photodetector 4.

The end face of the light guiding member 5 is cut at a predetermined angle θ with respect to the operating surface of the light guiding member 5, and a photodetecting surface is arranged in parallel to that face so that the photodetecting surface of the photodetector 4 becomes a plane orthogonal to the traveling direction of the totally reflected light 7b so as to receive the totally reflected light 7b as much as possible.

The light entering into the photodetector 4 causes the photodetector 4 to generate a photoelectric current. The photoelectric current is transmitted to a detection circuit (not shown) that judges whether the switch has been operated or not. In this preferred embodiment, only the light 7a totally reflected by the finger F goes into the inside of the light guiding member 5 and enters into the photodetector 4.

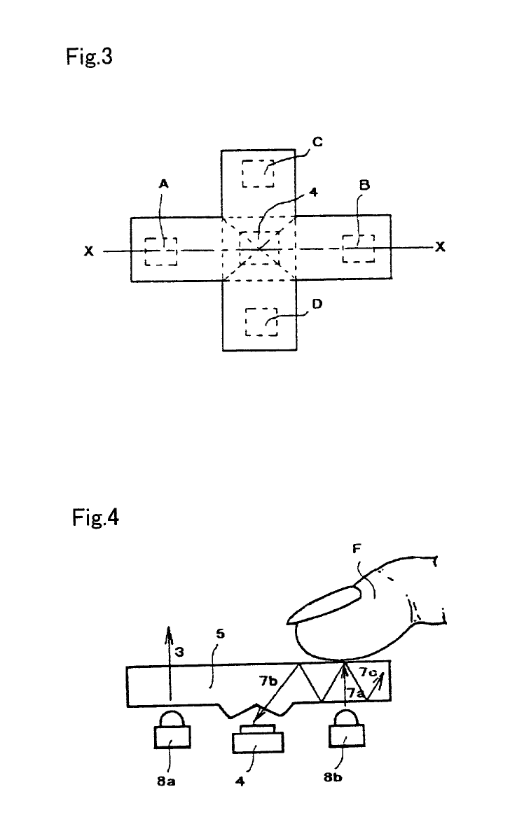

In an alternate embodiment of the invention, the optical touch switching device includes a plurality of optical touch switches incorporating the principle of the preferred embodiment described with reference to FIG. 1 and FIG. 2. FIG. 3 is a plan view of a simple example of such an alternate embodiment including four optical touch switches A, B, C and D. FIG. 4 is a sectional view taken along the line X-X in FIG. 3. In these figures, the shading member 6 described in the preferred embodiment of FIGS. 1 and 2 is omitted. In FIG. 4, reference numerals 8a and 8b denote light emitting devices, and 4 denotes a photodetector. The light emitting device 8a is a light emitting device for the switch A, and 8b is a light emitting device of the switch B.

Switch A includes a light emitting device 8a, the photodetector 4, and a light guiding member 5, and the switch B includes a light emitting device 8b, the photodetector 4, and a light guiding member 5. Here, the photodetector 4 and the light guiding member 5 are used in common.

FIG. 4 shows a case where the switch B is operated. When a finger F comes in contact with the surface of the light guiding member 5 arranged above the light emitting device 8b, light 7a emitted from the light emitting device 8b is reflected by the finger F, and of the reflected light, reflected light 7b satisfying the total reflection condition proceeds within the light guiding member 5, and the light enters into the photodetector 4 to generate photoelectric current and detect operation of switch B.

Similarly, when the finger F is brought into contact with the surface of the light guiding member 5 arranged above the light emitting device 8a, the outgoing light from the light emitting device 8a is reflected by the finger F, and a part of the reflected light proceeds within the light guiding member 5 and enters into the photodetector 4 to thereby generate photoelectric current. The current similarly enables detection of the operation of the switch A. The same principle applies to the switch C and the switch D.

With these operations, the light emitting devices do not emit light simultaneously, but the four light emitting devices emit light sequentially. Therefore, only one light emitting device emits light, and simultaneous emission does not occur. This light emission timing is controlled by a control circuit (not shown).

By controlling in this manner, if the timing at which the photoelectric current is generated by the photodetector 4 is studied, it can be judged which switch has been operated. That is to say, it can be easily judged by the control circuit whether the photoelectric current is generated at a timing corresponding to light emission from the switch A, or the switch B, or the switch C or the switch D. If the principle of the present invention is used in this manner, the switches can be constructed in any number, such as 10, 20 and so on. That is to say, the number of light emitting devices and switches can be the same, but at least one photodetector can be sufficient.

In general, in many cases, the optical touch switching device used for the operation panel has such a construction in which the switches are arranged in a matrix. The present invention can be easily applied to switching device having such a construction. In this case, one photodetector can be used with a plurality of light emitting devices. When the photodetector is small or the signal (light) to be received is small, one photodetector can be arranged for each line, in order to increase the sensitivity, and detection can be performed from any of these photodetectors.

In the description up to now, it has been described that when a finger is brought into contact with the surface of the light guiding member, the light emitted from the light emitting device is reflected by the finger, the reflected light proceeds within the light guiding member and enters into the photodetector, thereby the operation of the switch is detected. However, even if a finger is not always brought into contact with the surface of the light guiding member, as the finger approaches, light reflected by the finger increases. Accordingly, the light entering into the photodetector also increases with the approach of the finger, and it can be also detected that the finger approaches the light guiding member.

Although it is possible to use one photodetector, if the number of switches or the size of the operation panel is large, it is possible that the quantity of light entering into the photodetector would decrease thereby decreasing the detection capability of the photodetector. In such a case, as described with respect to the switching device arranged in a matrix, the number of photodetectors can be increased, as required, to maintain an adequate light detection capability.

Moreover, the direction of the outgoing light of the light emitting device is preferably perpendicular with respect to the surface of the light guiding member that receives the outgoing light. If the direction thereof is oblique, when there is no approach or contact of the finger for the operation, a part of the outgoing light from the light emitting device would turn into reflected light within the light guiding member, and this reflected light would enter into the photodetector, thereby causing a decrease in the detection sensitivity. That is to say, there would be no difference in output of the photodetector between a case where the switch is operated and a case where the switch is not operated. Hence, in order to increase the detection sensitivity, it is desired to arrange the light emitting device so that the direction of the outgoing light of the light emitting device is perpendicular with respect to the surface of the light guiding member that receives the outgoing light.

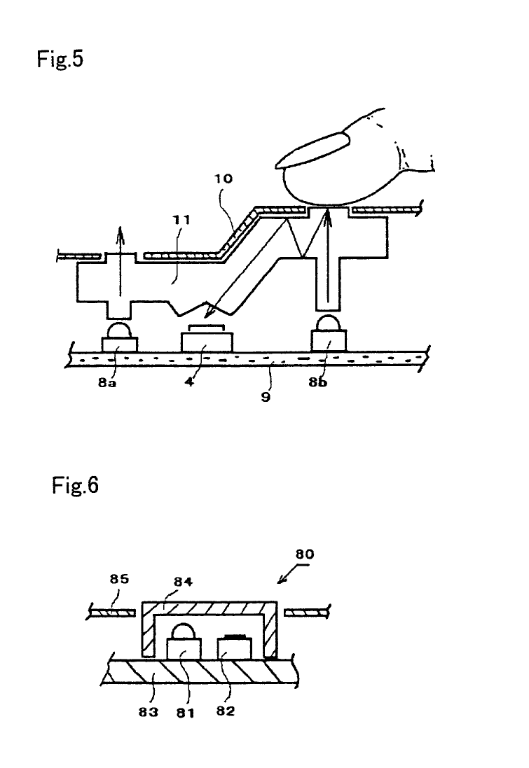

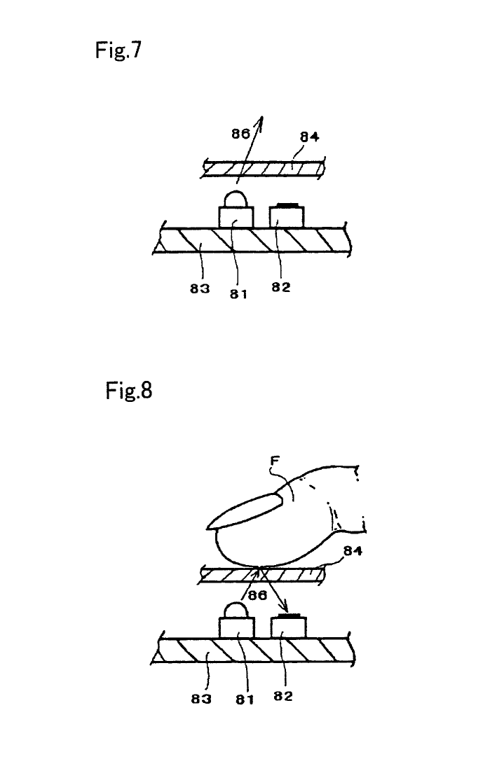

Also in the case where there the surface of the operating panel is non-planar, heretofore, a conventional optical touch switching device cannot be used. With the present invention, however, the shape of the light guiding member can be changed, thereby enabling easy correspondence therewith. FIG. 5 shows such an embodiment. Light emitting devices 8a, 8b and a photodetector 4 are mounted on a printed board 9. As shown in the figure, the operating surface of the apparatus surface panel 10 is not a flat surface, but has a raised portion. A light guiding member 11 is arranged between the light emitting devices 8a, 8b and photodetector 4, and the operating surface. The thickness thereof changes in the vertical direction, as viewed in FIG. 5, with respect to the operating surface depending on the gap between the operating surface and the printed board. In this manner, the light emitted from the light emitting device 8b, for example, can be guided to the photodetector via the light guiding member 11.

Moreover, the light emitting device can be controlled to emit light for only short periods of time such that the operation of the switch can be determined only during this time interval. That is, the photodetector can only be generate output of indicating operation or no operation of the switch during this time interval. Since this time interval for light emission is relatively small, it is contemplated to use the time between successive emissions for illuminating the periphery of the switch or providing a display.

The periphery of the switch can be illuminated so as to make it easy to operate the switch during the night, by adopting the light emitting device as a visible light emitting device and making the device emit light during the free time. Also, when the switch is operated, response can be displayed, indicating if the switch has been operated correctly or not. Needless to say, it is also possible to display other information. Moreover, both of the illumination and display can be performed at the same time, for example, by flashing the response display on and off for a short period of time, while the light emitting device is emitting light for illumination.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An optical touch switching device, comprises:
a plurality of switch operating surfaces engageable by an operator's finger;
a light emitting device corresponding to each of the plurality of switches;
a photodetector;
a light guiding member between the light emitting devices and the switch operating surfaces;
wherein the light guiding member transmits light from the light emitting device and an operator's finger reflects the light when the finger is spaced a distance from any one of the switch operating surfaces, and the light guiding member transmits light from the light emitting device and an operator's finger reflects the light when the finger spaced less than the distance from any one of the switch operating surfaces, thereby enabling determination of operation of the switch by an output from the photodetector.

2. The optical touch switching device according to claim 1, wherein light from the light emitting device is perpendicularly incident to the light guiding member.

3. The optical touch switching device according to claim 1, wherein at least one of the switch operating surfaces lies in plane different from another one of the switch operating surfaces; and
the light guiding member has a thickness in a direction perpendicular to the one switch operating surface and at a position corresponding to the one switch operating surface that is different from a thickness in a direction perpendicular to the another switch operating surface and at a position corresponding to the another switch operating surface.

4. The optical touch switching device according to claim 1, further comprising a light emitting timing output for each of the plurality of light emitting devices indicating which one of the plurality of switches has been operated.

5. The optical touch switching device according to claim 1, wherein each of the plurality of light emitting devices being associated with a respective one of the plurality of switches; and
each of the plurality of light emitting devices selectively emitting light between one of a switch operation detection mode, a switch illumination mode, and a plurality of display modes.

6. The optical touch switching device according to claim 1, the light guiding member is configured to permit light that is perpendicularly incident to a surface of the light guiding member to exit the light guiding member and to reflect light that is obliquely incident to a surface of the light guiding member.

7. The optical touch switching device according to claim 1, wherein the light guiding member extends from the each of the light emitting devices to the photodetector to provide a light transmission path from each of the light emitting devices to the photodetector.

8. An optical touch switching device, comprises:
a switch operating surface engageable by an operator's finger;
a light emitting device on one side of the switch operating surface;
a photodetector on the one side of the switch operating surface; and
a light guiding member between the light emitting device and the switch operating surface, the light guiding member includes a surface that transmits light that is incident to the surface in a perpendicular direction and reflects light that is incident to the surface in an oblique direction;
wherein light from the light emitting device passes through the light guiding member and outwardly of the switch operating surface when an operator's finger is at least a distance away from the switch operating surface, and light reflects off an operator's finger and into the light guiding member when the finger is less than the distance away from the switch operating surface;
wherein the light guiding member transmits the reflected light to the photodetector to generate an output indicating switch operation.

9. The optical touch switching device according to claim 8, the light guiding member has an incident surface associated with the light emitting device and an incident surface associated with the photodetector.

10. The optical touch switching device according to claim 8, wherein the light emitting device selectively emits light between any one of a switch operation detection mode, a switch illumination mode, and a plurality of display modes.

11. The optical touch switching device according to claim 10, wherein light from the light emitting device passes through the switch operating surface when the light emitting device is in the switch operation detection mode.

12. The optical touch switching device according to claim 11, wherein light from the light emitting device illuminates the periphery of the switch operating surface when the light emitting device is in the switch illumination mode.

13. The optical touch switching device according to claim 12, wherein light from the light emitting device creates a display of information when the light emitting device is in any one of the plurality of the display modes.

14. The optical touch switching device according to claim 8 further comprises a shading member extending between the light emitting device and the photodetector.

15. The optical touch switching device according to claim 8, wherein the photodector is at an angle relative to the path of the light emitted from the light emitting device.

16. The optical touch switching device according to claim 8, wherein the light emitting device emits infrared light.

17. The optical touch switching device according to claim 8, wherein the light emitting device emits visible light.

18. The optical touch switching device according to claim 8, wherein the light guiding member provides a light transmission path from the light emitting device to the photodetector.
